(19) United States
(12) Patent Application Publication
(10) Pub. No.: US 2011/0041795 A1
(43) Pub. Date: Feb. 24, 2011

(54) Method for producing a housing for an engine-or gearbox mount and housing produced with the method

(75) Inventor: Jörg Scharf, Eppenrod (DE)

Correspondence Address: Hildebrand, Christa;Norris McLaughlin & Marcus PA, 875 Third Avenue, 8th Floor, New York, NY, 10022, US

(73) Assignee: ZF FRIEDRICHSHAFEN AG, Friedrichshafen (DE)

(21) Appl. No.: 12/852,900

(22) Filed: Aug. 9, 2010

(30) Foreign Application Priority Data
Aug. 19, 2009 (DE) 10 2009 028 643.8

(51) Int. Cl. B60K 5/12; B23P 15/00

(52) U.S. Cl. 123/195 A; 29/428

(57) ABSTRACT

A housing of a engine or gear box mount and its manufacture is provided. The engine or gearbox mount can be cost-effectively manufactured from extruded profiles by interlocking at least two mutually orthogonal and preferably non-positively and positively connected segments (1, 2) of preferably differently configured profiles, while attaining a high loading capacity of the support housing even transverse to the main loading direction. The completed mount housing is formed when the engine- or gearbox mount to be received by the housing is installed at the predetermined installation site, when the sections forming the housing are connected at the same time.

### BACKGROUND OF THE INVENTION

(1) Field of the Invention

The invention relates to the housing of an engine- or gearbox mount which is used, in particular, for supporting the internal combustion engine of an automobile with the purpose of damping oscillations and/or vibrations caused by the internal combustion engine. The invention also relates to a method for producing the housing of a support of the aforedescribed type and to a housing produced with this method.

Within the context of the intended application, engine- or gearbox mounts for automobiles typically include a metallic housing, sometimes also a housing made of plastic. The respective housing is generally used for attaching the support at a predetermined mounting location.

(2) Description of Related Art

Conventionally housings which have an inside contour adapted to the outside contour of the engine- or gearbox mount received therein, are mostly constructed of welded steel structures or of one-piece extruded profiles. Extruded profiles can advantageously be easily fabricated. For realizing the housing of a mount, a section having a length corresponding to the dimensions of the mount is cut from a continuous run of an extruded profile, and this section is placed over the mount like a cap in the main loading direction of the engine- or gearbox mount, wherein the mount is attached at the mounting location to, for example, flange-shaped areas of the profile segments with screws via openings provided in these areas.

The housing support can be manufactured very cost-effectively as a segment from a continuous run of an extruded profile, because these components can be readily manufactured in large quantities. Housing shapes produced from extruded aluminum profiles have proven to be particularly advantageous for the intended use of the support or of its housing. Advantageously, aluminum has high-strength and high ductility. In particular, the latter property is very advantageous in view of the fact that the support is during operation subjected to relatively high mechanical loads, for example tensile loads. Because the housing made of extruded aluminum profiles has a high elongation limit, loading of the support normally does not damage the housing or tears the support from the installation location. In addition, the use of extruded profiles made of aluminum for the mount housing advantageously reduces the weight significantly compared to a welded steel structure. The weight is also reduced compared to housings made by die casting, because the latter have a relatively large wall thickness.

The aforementioned advantages of mount housing s produced from one-piece extruded profiles are negated by the fact that the mount housing has a high tensile strength and loading capacity essentially only into the main loading direction of the drive train bearing, because the respective housings are open on both sides in the extrusion direction of the respective profile segment forming the housing. To sustain higher loads also in this direction, the housings would have to be shaped so as to form supporting structures orthogonal to the extrusion direction. However, this is not possible with conventional extruded profiles.

### BRIEF SUMMARY OF THE INVENTION

It is an object of the invention to provide a solution for realizing housings for engine- or gearbox mounts, which can be easily manufactured and are able to withstand high loads, preferably in all directions. A method for achieving this will be described, as well as a corresponding mount housing.

The object is solved by a method having the features of the independent claim. A housing for an engine- or gearbox mount solving the object is characterized by the first device claim. More particularly, the mount housing characterized in the device claim can be produced with the method according to the invention.

The method according to the invention begins with the manufacture of a housing for an engine- or gearbox mount from extruded profiles. According to the invention, the housing of the engine- or gearbox mount is produced from at least two segments of preferably different or differently shaped extruded profiles, wherein the segments of the extruded profiles are first cut to suitable lengths. The housing is formed by connecting a segment of a first extruded profile forming a first housing section to at least one segment of a second extruded profile forming an additional housing section at the same time the engine- or gearbox mount is installed at the intended mounting location. The housing sections are connected by arranging them orthogonal with respect to the respective extrusion directions. In addition, the extruded profile segments are connected to each other and the engine- or gearbox mount is attached at the mounting location in one and the same operation, i.e., simultaneously.

The extruded profiles used for forming the housing sections are preferably produced from aluminum by extrusion.

The housing for an engine- or gearbox mount solving the object is configured for receiving and attaching the engine- or gearbox mount at a predetermined mounting location. According to the invention, the housing is made of at least two segments of a corresponding extruded profile. More precisely, the housing is made of a segment of a first extruded profile with a corresponding extrusion direction and of at least one second segment having a geometry which is preferably different from the geometry of the first extruded profile and which has an extrusion direction orthogonal to the extrusion direction of the segment of the first extruded profile. The segments of the extruded profiles are joined at a mounting location with the same fastening means that is also used for attaching the engine- or gearbox mount received by the housing.

According to a basic concept of the invention, an engine- or gearbox mount housing is constructed from extruded profiles which can be manufactured cost-effectively. A high load carrying capacity of the mount housing even perpendicular to the main loading direction can still be attained by interlocking at least two segments of these profiles, which are arranged orthogonal to each other and are preferably joined non-positively and positively. The mount housing is actually assembled in its entirety only at the customer or user when the engine- or gearbox mount to be received in the housing is installed at the predetermined mounting location, i.e., at the same time the components forming the housing are connected to one another. Advantageously, handling by the customer or user is facilitated due to the geometric shape of the housing sections which simplify assembly during installation of the support.

Preferably, to provide good ductility, at least one of the extruded profiles is constructed as an extruded aluminum profile. The aforedescribed fastening means, which is also used for connecting the housing sections, is preferably a screw.

According to a practical embodiment, the housing according to the invention is made of a segment of an extruded profile having a substantially U-shaped outside contour and an extrusion direction extending orthogonal to the main loading axis of the engine- or gearbox mount to be received by the housing, and of at least one bracket-shaped segment of a different extruded profile, which is arranged such that its extrusion direction is orthogonal to the extrusion direction of the U-shaped profile segment and parallel to the main loading direction of the engine- or gearbox mount. A passageway extending in the extrusion direction is arranged at the corresponding widened ends of the two legs of the U-shaped profile segment, and respective eyelets are formed at the ends of the short legs of the bracket-shaped profile sections. The short legs of the bracket-shaped profile segment with the eyelets formed thereon are brought into engagement with a corresponding passageway of the U-shaped profile segment, with the passageway forming a longitudinal guide. The short legs are pushed into the openings of the U-shaped profile segment, until the eyelets formed at their respective ends overlap with the openings which extend through the passageways of the U-shaped profile segment in the main loading direction of the engine- or gearbox mount. The engine- or gearbox mount is installed at the mounting location with corresponding screws which are screwed through the openings and the overlapping eyelets of the bracket-shaped profile segment. At the same time, the housing sections of the housing receiving the engine- or gearbox mount are connected with one another with these screws.

Aspects of the invention will now be described in detail with reference to an exemplary embodiment. The respective exemplary embodiment of the housing according to the invention is compared in the drawings with a conventional support housing. The drawing show in detail in:

### BRIEF DESCRIPTION OF THE SEVERAL VIEWS OF THE DRAWING(S)

FIG. 1 the housing sections forming the housing according to a possible embodiment of the invention, before being connected;

FIG. 2 the housing formed from the housing sections according to FIG. 1, and

FIG. 3 an engine- or gearbox mount with a conventional housing.

### DETAILED DESCRIPTION OF THE INVENTION

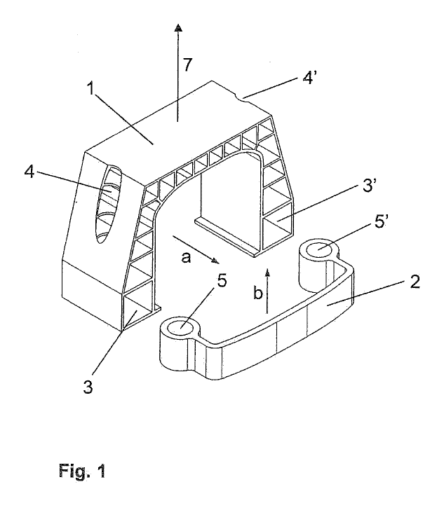

FIG. 1 shows in a three-dimensional representation two housing sections of a possible embodiment of the housing according to the invention before being connected to each other. Shown are a segment 1 of a first extruded aluminum profile and the segment 2 of an additional extruded aluminum profile having a simpler structure. The profile segment 1 forms a first housing section for an engine- or gearbox mount and is placed, with an overlap in the main loading direction 7, on a corresponding (unillustrated) drive train support much like a cap. The inside contour of this profile segment 1 is shaped to correspond to the outside contour of the unillustrated drive train support. The additional profile segment 2 forms a second bracket-shaped housing section. This housing section, or this segment 2 of an extruded profile, is, as shown in the drawing, arranged orthogonal to the first segment forming the first housing section. The orthogonal arrangement of the two housing sections, or profile segments 1, 2, relative to one another is in relation to the respective extrusion direction a, b of the profiles from which the housing sections were cut off as segment 1, 2. In the Figure, the extrusion direction of the profile segment 1 forming the first housing section is indicated with the letter “a”, whereas the extrusion direction of the profile segment 2 forming the second housing section is indicated with the letter “b”.

As illustrated in the Figure, two passageways 3, 3′ which extend along the extrusion direction a, are formed in the foot region on the two outer sides of the profile segment 1 forming the first housing section. In the illustrated exemplary embodiment, the passageways 3, 3′ have a rectangular or approximately square cross-section and hence approximately the shape of a box profile. The short legs of the bracket-shaped second housing section 2 are pushed into these passageways 3, 3′ for connecting the two housing sections with the inserted support. The short legs of the bracket-shaped second housing section 2 have at each of their respective ends an eyelet 5, 5′.

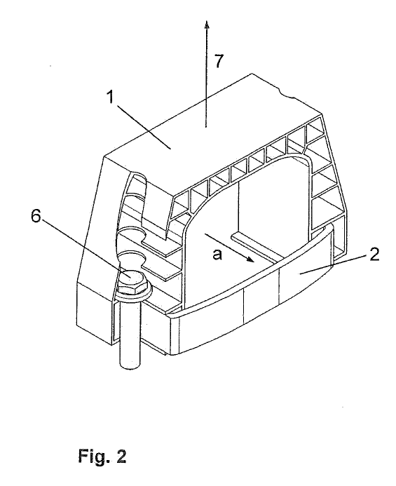

As indicated in FIG. 2, the length of the two short legs of the bracket-shaped second housing section 2 is dimensioned so that the eyelets 5, 5′ formed at their respective ends overlap with openings 4, 4′ when the surface element connecting the legs with each other makes contact with the first housing section 1. The openings 4, 4′ extend through the two passageways 3, 3′ of the first housing section 1, which operate as longitudinal guides, in the main loading direction 7 of the not illustrated drive train or engine support to be received by the housing. The two housing sections or profile segments 1, 2 are connected with each other with screws 6, while the not illustrated) drive train support received by the housing is simultaneously installed at the installation site. To this end, the screws 6 are guided through the openings 4, 4′ which extend transversely to the passageways 3, 3′ of the first housing section or profile segment 1, which is shown for clarity with a partial breakout, and through the eyelets 5, 5′ of the short legs of the bracket-shaped second housing section or profile segment 2, which overlap with these openings 4, 4′, shown here also with a partial breakout. The screw attachment produces a non-positive and positive connection between the two housing sections, wherein a non-positive connection is established in the extrusion direction a of the profile segment 1.

With the invention, complex housing geometries can advantageously be readily formed from low-cost extruded aluminum profiles, with the housing being formed by connecting the segments 1, 2 of these extruded profiles with one another. The housing has excellent load carrying capacity and/or deformability in all loading directions. The second housing section which is arranged orthogonal to the first housing section in relation to the corresponding extrusion directions a, b, forms a supporting structure normal to the extrusion direction a of the first housing section 1. Depending on the application and the required shape of the housing, the housing section formed by the profile segment 1 may also be in engagement on the other side with a third profile segment or housing section that is configured similar to the profile segment 2 and has the same extrusion direction as the profile segment 2. The use of aluminum in conjunction with the special housing geometry produces a low-weight housing, while exhibiting at the same time long elongation regions for all loading directions.

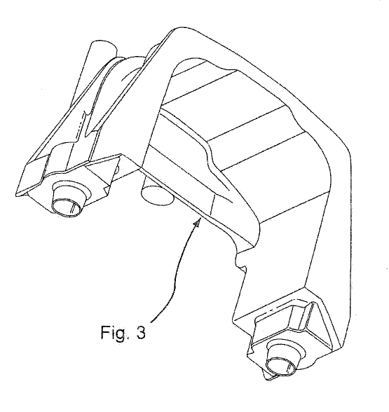

FIG. 3 shows in a three-dimensional view a conventional housing for an engine- or gearbox mount. The respective housing is formed by a segment of an extruded aluminum profile which is to be placed onto the engine- or gearbox mount in the main loading direction like a cap. This configuration allows only a comparatively small loading capacity of the mount housing in the extrusion direction.

1. A method for producing a housing for an engine or gearbox mount by using extruded profiles, the method comprising the steps of
producing the housing of the engine or gearbox mount from at least a first and a second segment of extruded profiles cut to length,
connecting the first segment of the first extruded profile having an extrusion direction (a) and forming a first housing section to at least one second segment of a second extruded profile having an extrusion direction (b),
forming an additional housing section so as to form the housing when the engine or gearbox mount is attached at its predetermined installation site,
wherein the first and the second segment are arranged for connection orthogonal to each other with respect to the extrusion directions (a, b) and the first and second segment are connected during the same operation as the engine or gear box mount is attached at the installation site.

2. The method according to claim 1, wherein the extruded profiles, from which the segments (1, 2) are cut, are made of aluminum by extrusion.

3. A housing for an engine or gearbox mount for receiving and attaching the engine or gearbox mount at a predetermined installation site, the housing comprising
at least a first and a second housing segment,
each segment having a corresponding extruded profile, wherein the first segment (1) of a first extruded profile has an extrusion direction (a) and the second extruded profile has an extrusion direction (b) orthogonal to the extrusion direction (a) of the first segment (1) of the first extruded profile,
wherein the segments (1, 2) of the extruded profiles are connected with one another by a fastening means (6) configured to simultaneously attach the engine or gear box mount received by the housing at an installation site.

4. The housing according to claim 3, wherein both the extruded profile for forming the first segment and/or the extruded profile for forming the second segment are constructed as an extruded aluminum profile.

5. The housing according to claim 3, wherein the housing sections formed from the first and second segment are connected with one another by forming a non-positive and positive connection.

6. The housing according to claim 5, wherein the housing sections formed from the first and second segment are connected with one another with at least one screw (6).

7. The housing according to claim 6, wherein the first segment of the extruded profile has a substantially U-shaped outside contour and wherein the extrusion direction (a) is orthogonal to a main loading direction of a engine or gearbox mount received by the housing,
wherein the second extruded profile is bracket-shaped which is arranged such that the extrusion direction (b) is orthogonal to the extrusion direction (a) of the U-shaped profile segment and parallel to the main loading axis direction (7) of the engine or gear box mount,
wherein a corresponding passageway extending along the extrusion direction (a) is arranged at the end of each of the two legs of the U-shaped profile segment and a corresponding eyelet is formed at the ends of the short legs of the bracket-shaped profile segment, and wherein the short legs of the bracket-shaped profile segment with the eyelets formed thereon engage with a corresponding passageway of the U-shaped profile segment which forms a longitudinal guide for the eyelets, so that the eyelets are brought into overlapping relationship with the openings, which extends through the passageways of the U-shaped profile segment in the main loading direction of the engine or gearbox mount,
wherein the engine or gearbox mount is attached by way of the openings with a corresponding screw at the installation site at the same time the engaged segments forming the housing are joined.
